(19) United States
(12) Patent Application Publication
(10) Pub. No.: US 2005/0033490 A1
(43) Pub. Date: Feb. 10, 2005

(54) Process and device for recording multimedia digital data associated hard disk recording medium and digital data string

(76) Inventors: Franck Abelard, Chateubourg (FR); Fabien Deschamps, Rennes (FR); Pascal Maetz, Chevaigne (FR); Christophe Rabu, Bruz (FR)

Correspondence Address: Joseph S Tripoli;Patent Operations-Thomson multimedia Licensing Inc, CN 5312, Princeton, NJ, 08543-0028, US

(21) Appl. No.: 10/451,896

(22) PCT Filed: Dec. 14, 2001
(86) PCT No.: PCT/EP01/14757

(30) Foreign Application Priority Data
Dec. 21, 2000 (DE) 100-63-889.9
Feb. 10, 2001 (DE) 101-06-163.3

(51) Int. Cl. G05D 1/00; G01C 22/00

(52) U.S. Cl. 701/25

(57) ABSTRACT

The present invention relates to a process and a device for recording multimedia digital data, preferably audio and/or video, on a direct-access recording medium. The data comprise broadcasting information and navigation information, sufficient to implement at least one mode of reading the recorded broadcasting information. During recording, the following operations are repeated: recording of new broadcasting information as it is received, determination and preservation in buffer memory of the associated navigation information and transfer of the navigation information by contiguous recording in a storage space within the recorded broadcasting information, which space is associated with the new recorded broadcasting information. This storage space has a predetermined size.

The present invention relates to a process and a device for recording a set of multimedia digital data, preferably audio and/or video, and to a corresponding hard disk, recording medium and digital data string.

A multimedia digital data set recorded on a direct-access recording medium (CD, DVD, hard disk etc) generally comprises, in addition to the broadcasting information, navigation information, making it possible to obtain at least one position in the said recorded broadcasting information. This information can, for example, comprise one or more read-positioning addresses of the broadcasting information.

The expression “broadcasting information” is understood to mean any information intended to be broadcast in the course of time from a recording medium, either directly to a broadcasting apparatus (television, audio deck, etc), or to a transmission channel. The broadcasting information advantageously relates to video signals, preferably audiovisual signals, but may also relate to purely audio signals or those of some other kind (for example olfactory, or pertaining to actions of automata). By convention, both the broadcasting information and the navigation information are referred to as “multimedia data”. The expression “direct-access recording medium” designates any recording medium permitting direct read-positioning, and possibly write-positioning, either at any position of the support, or at certain access positions.

In practice, in the case of an audiovisual stream compressed according to an MPEG standard such as MPEG-2, packets of the elementary train type or PES (Packetized Elementary Streams) or packets of the transport train type or TS (Transport Streams) are recorded on a hard disk or HDD (Hard Disk Drive).

In the known systems using a hard disk as recording medium, during normal reading (forward play at neither slow, nor fast speed) of the audiovisual Information, the navigation information is referred to initially so as to self-position on the disk, then the audiovisual information which follows is read sequentially. For the implementation of special effects modes, known as “trick modes”, the appropriate images are traversed and selected at the time of reading, and they are broadcast. The special effects modes may in particular consist of fast-forward or fast-reverse playbacks, slow motions or freeze frames.

These known techniques have the drawbacks of requiring, when reading in special effects modes, a bandwidth and, a memory which are of sufficiently large size to permit traversal of the set of images and selection of the suitable images. Moreover, the performance is bounded by the necessary operations. In particular, during reverse play, real-time reading is heavily penalized, or even excluded.

Recordable DVDs systems are also known, by means of which real-time information units are recorded successively, these units including playback parameters at the start of the units. These parameters comprise pointers to units disposed forward or backward of the unit which, contains them.

Thus, for example, the document WO-00/30113 describes a real time information recording method, in which a buffer memory allows temporary storage of the real time data received. A processing unit determines the pointers to neighbouring units based on the content of the buffer memory, while the pointers to distant units are fixed arbitrarily, on the basis of neighbouring units and/or of default values indicating that the targeted unit does not exist.

Such systems for recordable DVDs require frequent registering of the navigation information, owing to the limitations in available memory space, and offer reduced visibility to units upstream or downstream, on account of the disseminating of the navigation information within the broadcasting information.

The invention relates to a process for recording a set of digital broadcasting data on a direct-access recording medium, which makes it possible to improve reading performance, while also reducing the necessary bandwidth and memory, in particular in special effects modes.

The subject of the invention is also a corresponding recording device.

It also pertains to a hard disk and a direct-access recording medium, comprising broadcasting information and navigation information which can be written by means of the recording process of the invention, as well as to a multimedia digital data string which can be obtained by means of such a process.

The invention applies most especially to the audiovisual field, for which the broadcasting data are of the audio and/or video type. These digital data are, for example, coded by MPEG methods, such as MPEG-2 or MPEG-4. More generally, it comes within the scope of multimedia. Moreover, it is most especially beneficial in respect of recordings on hard disk.

Accordingly, the invention relates to a process for recording a set of multimedia digital data, preferably audio and/or video, on a direct-access recording medium, from a received stream comprising at least broadcasting information. This set comprising the said broadcasting information and navigation information, sufficient to implement at least one mode of reading the broadcasting information recorded on the recording medium.

According to the invention, the following operations are repeated:
new broadcasting information is recorded on the recording medium as and when this broadcasting information is received,
the navigation information associated with the new broadcasting information recorded on the recording medium is determined and this navigation information is held in buffer memory, for example in a random access RAM memory,
and the said navigation information contained in buffer memory is transferred to the recording medium, while recording it contiguously in a storage space which is disposed within the said recorded broadcasting information and is associated with the said new recorded broadcasting information, this storage space having a predetermined size.

The determined navigation information recorded on the recording medium, whether it be fully determined locally or merely supplemented locally, is preferably sufficient to implement at least one mode of reading the broadcasting information of the set of data recorded on the recording medium. Thus, it is not necessary to determine other information at the time of reading according to this mode. This information therefore gives a virtual model of the broadcasting information recorded on the medium, on which is based read-processing, in particular in respect of special effects modes.

The navigation information comprises addresses, such as for example positions (or indices) of packet headers, of sequences, of groups of images (or GOPs standing for Groups Of Pictures) and/or of images. It also advantageously comprises spacing details (such as numbers of images or times elapsed since the start of a given recording—time indexing) making it possible to access remote positions (in particular for very fast forwarding or positionings at places chosen by a user) and/or details describing objects (for example types of video coding or image structures).

The navigation information is “associated” with the new broadcasting information, in the sense that the navigation information applies to this broadcasting information.

The predetermined size of the storage spaces scheduled to contain the navigation information is either a directly fixed size or a size obtained by means of an obtaining criterion, for example as a function of a predetermined temporal frequency of recording of the navigation information for a given image quality or as a function of the bit rate of the received stream. Preferably, the size required is independent of the bit rate. The spatial frequency of the navigation information is then generally a decreasing function of the bit rate of the stream. Specifically, for example, an improvement in the quality of the images leads to a consequent increase in the audiovisual information but only marginally affects the required amount of navigation information as a function of time. The size of the audiovisual information lying between successive items of navigation information is therefore increased.

The size required for the navigation information, or the associated criterion, is determined as a function of the memory space available on playback, as well as by making a compromise in particular between speed of access to the navigation information and speed of access to the broadcasting information. Specifically, the larger the size of navigation information groups, the more voluminous the broadcasting information sequences lying between two of these groups, since each of these groups relates to a larger quantity of broadcasting information. The navigation information is then more spaced out and not as rapidly accessible (low granularity), but offers a longer range of access to the broadcasting information recorded upstream and/or downstream (greater centralization of the navigation information, hence better visibility). Moreover, the stream of broadcasting information is less frequently interrupted.

Advantageously, the criterion for determining the size of navigation information groups contained in the storage spaces consists in deducing this size from a predetermined temporal frequency of recording the navigation information for a given image accuracy, for example one recording every 12 seconds. The duration between two recordings is then preferably roughly equal to a value lying between 10 and 15 seconds. According to another embodiment, the size of the, navigation information groups is imposed, for example roughly equal to a value lying between 25 and 40 k-bytes, such as 32 k-bytes.

The recording of the navigation information “within” the already recorded broadcasting information must be interpreted as including the case of a recording immediately downstream of this broadcasting information.

Preferably, however, each of the navigation information groups is registered upstream of the associated broadcasting information, and even upstream of the last broadcasting information associated with the previous group of navigation information.

Thus, the recording process of the invention is such that all the navigation information required for implementing the desired modes of reading is already directly available at the time of reading. Hence, contrary to the hard disk based known techniques in which no appropriate navigation information is available at the time of reading, it is not necessary to scan the broadcasting information and to provide for placement in intermediate buffer memory in order to select the suitable information. The performance of the present technique is especially beneficial during reverse running. Even during normal reading, this process is advantageous, since the successive information (for example the images in respect of video) are accessed directly in the course of time.

Moreover, the navigation information is grouped together in subsets with the corresponding broadcasting information, thereby again considerably increasing the efficiency of the system during reading.

Specifically, the read head jumps may thus be considerably reduced or even eliminated (depending on the modes of reading) as compared with what is required for an apportioning of the broadcasting information and navigation information respectively into two separate files. The latter mode of storage is however practical and natural, since the structure of the stream is complied with by continuous recording of the broadcasting information stream and by grouping the navigation information together with other management information.

However, during reading it entails successive to and fro journeys between the two files, there being a risk of these files being sited at remote locations on the recording medium. Data transfer is thus penalized by the time lags (referred as the “Seek Time”) required for the reading head to accurately reach the necessary positions. For certain special effects modes requiring rapid alternation, such as fast reading, the playback efficiency is particularly impaired, this leading on the one hand to a significant bandwidth loss and on the other hand to operating noise related to the movement of the head.

As compared with this technique, the present method makes it possible to decrease the access times and the generation of noise, and to increase the bandwidth. These advantages prove to be particularly useful when a recording is in progress during the activation of a special effects mode, since a larger bandwidth is thus available.

The solution of the invention runs counter to the received wisdom in the field of hard disks, since a person skilled in the art would naturally be inclined to think that the writing of data is greatly penalized in terms of bandwidth if broadcasting information and navigation information sufficient for implementing the modes of reading, most particularly when dealing with special effects modes, is interposed. He would in fact imagine that this entails performing frequent jumps of the head in order to access the necessary positions during recordings. Now, contrary to this preconception, it is observed that; for recordings on hard disks, the access times are essentially hidden by the cache mechanism conventionally built into the disk. Thus, the access times generated in write mode by the recording process according to the invention are transparent in respect of the performance of the system. The head jumps in write mode are all the less penalizing since recording is performed at the speed of reception of the stream, while playback can be performed at fast speed.

As compared with the existing techniques for recordable DVDs, the recording process of the invention allows a considerable reduction in the buffer memory requirements, because only the navigation information is required to be kept. It therefore permits a much bigger spacing of the groups of navigation information, and thus better upstream and/or downstream visibility in regard to the broadcasting information.

Moreover, by virtue of the use of a predetermined size of the storage spaces for the navigation information, this process permits automatic adaptation of the spatial frequency of the navigation information as a function of the bit rate. This permits systematic allowance for the variations in the quality of the broadcasting information, such as image accuracy. Specifically, superfluous fragmenting of the navigation information Is avoided, without impeding the ease of access in playback mode of the broadcasting information. The efficiency of the system is therefore improved. This automatic adaptation is advantageously independent of the number of pack t identifiers or PIDs, this making it possible to allow for several original information streams multiplexed in the recorded data set.

Since the recording medium is advantageously a hard disk, the consecutive locations correspond specifically to logic block addresses or LBAs immediately following one another. The broadcasting and navigation information is thus grouped together in one and the same file of the disk.

Techniques for writing audiovisual information and navigation information onto disk, at separate and nonintermingled locations, are described in the prior patent applications PCT/EP-00/09903, EP-00400941.1 and EP-00402115.0, not published at the time of filing of the present patent application. These documents explicitly refer to types of navigation information which can be used for reading in special effects modes. They also detail techniques for extracting navigation information, which are applicable to the process of the present invention.

In accordance with a technique thus described in these documents, PES or TS packets of a compressed audiovisual stream (broadcasting information) are recorded on a hard disk, the information of the stream is analysed (parsing), for example by means of an FPGA (Field Programmable Gate Array) circuit or a central processing unit or CPU, it is played back and it is processed by means of a CPU, then it is stored on the hard disk. The trick mode information thus obtained contains a descriptive of the audiovisual stream and access addresses for audiovisual information on the disk.

Preferably, the navigation information contained in buffer memory is transferred to the recording medium when this navigation information reaches the predetermined size. Any excess navigation information as compared with the size of the storage space Is then kept if necessary, for recording in a subsequent storage space.

In a variant implementation, the navigation information is record d on the recording medium as and when it is determined. In this case, an indicator of the size reached by the set of navigation information already recorded in the storage space is preserved in memory. This implementation requires that the storage space be already allocated within the broadcasting information, at the start of the transferring of the corresponding navigation information.

According to a first form of disposition of the navigation information on the recording medium, the navigation information associated with a sequence of broadcasting information recorded on the recording medium is recorded immediately downstream of this sequence.

This implementation follows the logic for making the information available when performing a syntactic analysis of the broadcasting information of the stream so as to produce the navigation information, and it is advantageous on account of its simplicity. Specifically, the broadcasting information is available before the associated navigation information, so that the former is recorded before the latter. However, jumps of the head in read mode remain systematic, since the navigation information of the group must be read before the broadcasting information of the associated sequence, even in normal playback mode.

According to a second form of disposition of the navigation information on the recording medium, the following operations are repeated:
before the new broadcasting information is recorded on the recording medium, the storage space scheduled to contain the navigation information associated with this new broadcasting information is allocated on the recording medium consecutively to the previously recorded broadcasting information,
the new broadcasting information is recorded downstream of this storage space,
and the determined navigation information held in buffer memory and associated with the said new broadcasting information is recorded, in this storage space.

This interleaved disposition is particularly advantageous during reading and allows a further reduction in head jumps, and hence an improvement in performance. It even permits continuous reading of the set of navigation and broadcasting information during forward play. Specifically, it is possible to read, with no head jumps, the navigation information of the group before the broadcasting information of the associated sequence. In write mode, head jumps are by contrast necessary:
backwards for the recording of the navigation information which becomes available after the broadcasting information,
and forwards for the recording of the new broadcasting information, just after the registering of the navigation information associated therewith.
   However, these jumps in write mode do not penalize the bandwidth, for the reasons mentioned above.

Moreover, proceeding thus is advantageous since it makes it possible to undertake the writing of the broadcasting information in real time, without waiting for the acquisition of the associated navigation information. The locations of the storage spaces allocated during the first step are, for example, stored in a data management file, by means of the file system.

The expression “to allocate a space”, is understood as meaning either to make this space available through a specific command, or to write non-significant information, such as zeros, into this space. This latter implementation is used preferably for writing to hard disk, for which there is generally no specific memory allocation command.

The operations defined for this form of disposition do not apply, by exception, to the allocating of the first storage space for the navigation information: this space is allocated at the start of recording, upstream of the first broadcasting information saved.

Moreover, the new broadcasting information recorded downstream of the storage space does or does not adjoin this space.

Preferably, an intermediate space is scheduled between the storage space for the navigation information and the start location for the associated broadcasting information, by repeating the following operations:
one of the storage spaces, the so-called current storage space, is allocated when the navigation information, the so-called upstream navigation information, associated with the new broadcasting information received, the so-called upstream broadcasting information, reaches a predetermined fraction of the predetermined size,
the recording on the recording medium consecutively to the said current storage space, of the upstream broadcasting information, is continued, as is the determination of the associated upstream navigation information,
the said upstream navigation information is recorded in one of the storage spaces, the so-called upstream storage space, previously allocated to the current storage space,
new broadcasting information, the so-called current broadcasting information, is recorded consecutively to the upstream broadcasting information,
the navigation information associated with the current broadcasting information, the so-called current navigation information, is determined and held in buffer memory,
one of the said storage spaces, the so-called downstream storage space, is allocated consecutively to the recorded current broadcasting information, when the current navigation information reaches the predetermined fraction of the predetermined size,
the recording on the recording medium consecutively to the downstream storage space, of the current broadcasting information, is continued,
the current navigation information is recorded in the current storage space, and
new broadcasting information, the so-called downstream broadcasting information, is recorded consecutively to the current broadcasting information and the associated navigation information, the so-called downstream navigation information, is determined and held in buffer memory.

This implementation may make it possible to ensure that the navigation information is always upstream of the associated broadcasting information, in so far as the predetermined fraction of the necessary size is not too high. Specifically, even when there is excess navigation information as compared with the capacity of the current storage space, that is to say when an overshoot of the predetermined size occurs, this excess navigation information then relates to broadcasting information saved after the allocating of the succeeding storage space. This excess navigation information is therefore actually placed upstream of the associated broadcasting information, in this succeeding storage space.

The operations defined for this particular form of implementation do not apply, as seen above, to the allocating of the first storage space. By another exception, neither do they apply to the recording of the broadcasting information associated with the last storage space: this last broadcasting information is recorded continuously, which no new allocation of storage space.

Advantageously, the predetermined fraction of the predetermined size lies between 75% and 85%, and preferably between 79% and 81%, of this size.

Preferably, the reading modes implementable by means of the navigation information comprise at least one special effects mode (or trick mode). It is in fact for such modes that the process of the invention is especially beneficial.

In a first form of utilizing the data recorded on the recording medium, the broadcasting information is read in cooperation with the navigation information, so as to be broadcast directly to a user. The recording medium is then, for example, a hard disk incorporated into a receiver with built-in MPEG decoder, also referred to as a set-top box or IRD (Integrated Receiver Decoder).

In a second form of utilization of the data recorded on the recording medium, the data set recorded on the recording medium is sent to at least one recording apparatus comprising a direct-access final recording medium.

The recording medium used initially then constitutes an intermediate medium, which makes it possible to establish reference navigation addresses. The addresses actually used in the final recording medium (hereinafter the “final addresses”) differ therefrom, but they may be deduced simply from the reference addresses. For example, the final addresses are obtained by a simple shift of the reference addresses, based on the positioning of the data in the final medium at the start of a location available for recording.

The intermediate medium is advantageously included in a server, from which transmissions are sent to individual apparatuses. For example, transmission is performed by waves and several of the receiving apparatuses are fitted with hard disks. These receiving apparatuses are then furnished with systems for recognizing data recordable on hard disk, for example by means of a signal dispatched by the server at the start of transmission.

According to a first mode of obtaining the navigation information, at least part of this information is produced by performing a syntactic analysis (parsing) of the broadcasting information of the stream received. Advantageously, this information is played back later and is processed by means of a CPU, before being recorded.

According to a second mode of obtaining the navigation information, because the stream received is analogue, the navigation information is produced by encoding the stream after digitization. For example, because the broadcasting information is audiovisual, recourse is had to a reception system comprising an MPEG coder, such as a Personal Video Recorder or PVR. There is then coding of the stream received in real time by generating the navigation information directly by means of the coder.

According to a third mode of obtaining the navigation information, intermediate navigation information in the received stream is received, and it is adapted and completed before being recorded. In particular, this intermediate navigation information is advantageously received from a recording system implementing the recording process of the invention by means of an intermediate medium. It then merely remains to perform a simple adjustment of the addresses received, as is indicated above.

Advantageously, extra information, such as for example temporal information or location of details regarding the navigation information (non-real time information, such as indices for positioning according to the activated mode of reading), is recorded in initial locations, ahead of those of the groups and sequences. Head jumps in read mode are thus again reduced, since one avoids recourse to a separate description file. The extra information contained in the initial locations should then be updated during recording.

However, it is beneficial moreover to employ a separate file (of the file system type) for information not relating to navigation: dates of creation of files, location of these files, organization of directories, etc.

In an advantageous implementation when encrypted transport trains (scrambling) are stored on the recording medium, the navigation information contains decryption keys.

The invention also pertains to a device for recording sets of multimedia digital data, preferably audio and/or video, on a direct-access recording medium, from a received stream comprising at least broadcasting information. These sets comprise the broadcasting information and navigation information, sufficient to implement at least one mode of reading the broadcasting information recorded on the recording medium.

According to the invention, said recording device is scheduled for implementing the recording process according to any one of the forms of implementation of the invention.

The invention additionally relates to a hard disk on which is recorded at least one set of multimedia digital data, preferably audio and/or video, having direct access. These data comprise broadcasting information and navigation information making it possible to obtain at least one position in the recorded broadcasting information.

According to the invention, the said hard disk comprises in consecutive locations, sequential blocks each comprising a sequence of broadcasting information and a group of navigation information, which group is associated with this sequence or with the sequence of the sequential block immediately downstream of this sequence. The navigation information is sufficient to implement at least one mode of reading the broadcasting information of the recorded data set.

The invention also relates to a medium for recording at least one set of multimedia digital data, preferably audio and/or video, having direct access. The support comprises a succession of sequential blocks each comprising a sequence of broadcasting information and a group of navigation information, which group is associated with broadcasting information downstream of this group. Furthermore the navigation information is sufficient to implement at least one mode of reading the broadcasting information of the recorded data set.

According to the invention, the groups of navigation information are inserted into the sequences of broadcasting information: each of the said sequences of broadcasting information consists of an upstream subsequence and of a downstream subsequence which are separated by one of the groups of navigation information, and this downstream subsequence is associated at least partially with navigation information upstream of the upstream subsequence.

This recording medium can be obtained in particular by means of the implementation of the recording process of the invention, in which the storage spaces are allocated when the current navigation information reaches a predetermined fraction of the size required. It contrasts with recordable DVDs, in which each group of navigation information immediately precedes the sequence of associated broadcasting information.

The invention also relates to a string of multimedia digital data, preferably audio and/or video, which is intended to be recorded on at least one direct-access recording medium. This string comprises a succession of sequential blocks each comprising a sequence of broadcasting information and a group of navigation information, which group is associated with broadcasting information downstream of this group. The navigation information is sufficient to implement at least one mode of reading the broadcasting information of the data set recorded on the recording medium, by dint of prior tailoring of the navigation information to the recording medium.

According to the invention, the groups of navigation information are inserted into the sequences of broadcasting information, each of the sequences of broadcasting information consisting of an upstream subsequence and of a downstream subsequence which are separated by one of the groups of navigation information, and the downstream subsequence being associated at least partially with navigation information upstream of the said upstream subsequence

The invention will be better understood and illustrated by means of the following exemplary embodiments and exemplary implementations, which are in no way limiting, with reference to the appended figures in which:

FIG. 1 is a basic diagram of an apparatus for recording and reading multimedia digital data in accordance with the invention;

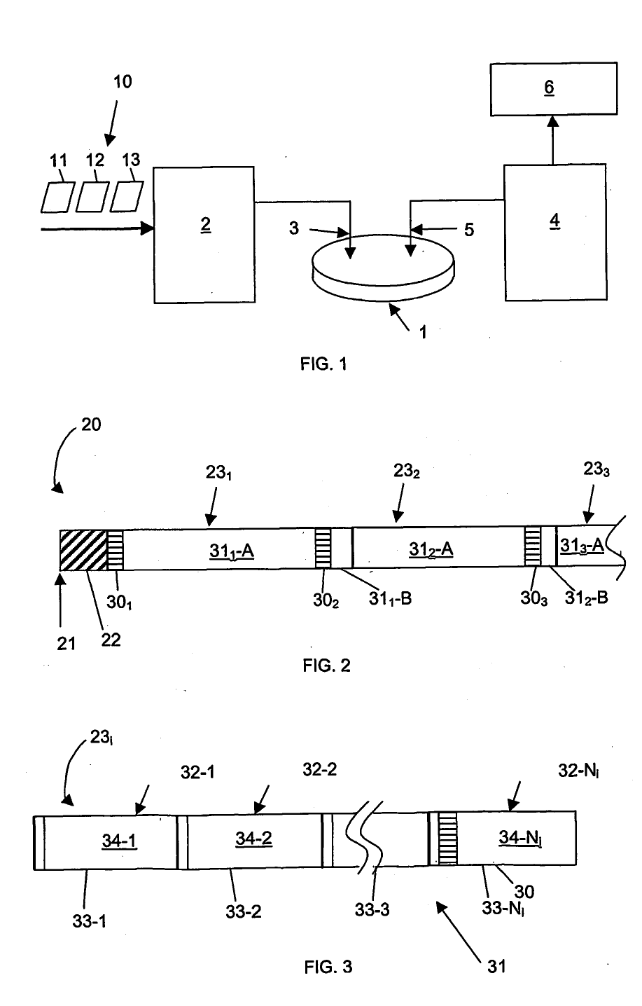

FIG. 2 represents a first mode of recording on hard disk obtained by means of the apparatus of FIG. 1

FIG. 3 details an enlargement of a sequential block of the recording of FIG. 2;

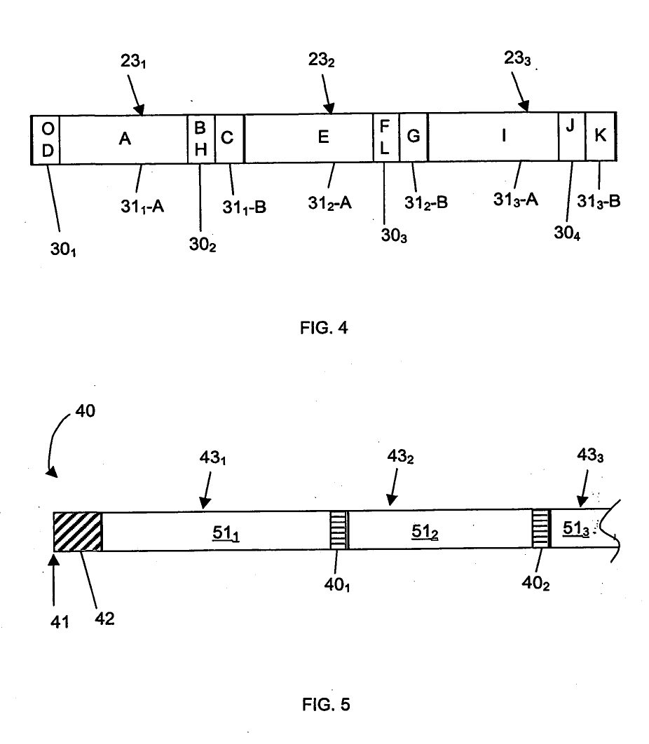

FIG. 4 indicates on a diagrammatic illustration of the recording of FIG. 2, the order of the operations for recording on the disk;

FIG. 5 represents a second mode of recording on hard disk obtained by means of the apparatus of FIG. 1.

In FIGS. 2 to 5, the dimensions used to represent the various storage areas for the data are not representative of the real dimensions and of their ratios, but have been adopted for the sake of clarity.

An apparatus for recording and reading multimedia digital data (FIG. 1) on a hard disk 1 comprises a recording device 2 and a reading device 4. This apparatus consists for example of an IRD, quipped with a recording hard disk.

The recording device 2 comprises a head 3 for recording on the disk 1 sets of audiovisual data, from audiovisual information streams 10 composed of 11, 12, 13 PES or TS packets. The audiovisual information received is subjected before recording to a processing, which includes a syntactic analysis (parsing) leading to the extraction of navigation information, in particular appropriate to the implementation of special effects modes (“trick mode information”), and also for normal reading. The recording device 2 is furnished in particular with means for producing all the useful addresses for the various scheduled modes of reading (such as forward play, fast or very fast reading, reverse play at normal, fast or very fast speed, etc).

For its part, the reading device 4 comprises a head 5 for reading on the disk 1 audiovisual data previously registered, for example for decoding and display on a screen 6 or for transmission on a communication bus. In embodiments derived from conventional appliances, the recording head 3 and reading head 5 are one and the same, the recording device 2 and reading device 4 possibly constituting a single device having both write and read functionalities.

In a first embodiment, the recording device 2 registers the set of audiovisual and navigation information (FIG. 2) in one and the same area 20 of the disk 1, forming a file. At the start 21 of the file, the device 2 registers a block of general information 22, followed by successive sequential blocks 23₁, 23₂, 23₃ . . . , respectively relating to successive audiovisual sequences of the stream 10.

The block of general information 22 comprises descriptive particulars regarding the entire file. It is updated during recording. One or more information clusters are assigned to it. Each of the sequential blocks 23ᵢ (generic notation 23) comprises an audiovisual sequence 31ᵢ and a group 30ᵢ₊₁ of navigation information (generic notation 30) having a required size and associated with a later audiovisual sequence 31ᵢ₊₁.

The audiovisual sequence 31₁ is split into two subsequences 31ᵢ-A et 31ᵢ-B, separated by the group 30ᵢ₊₁ of navigation information. Thus, the sequential block 23ᵢ comprises, at consecutive positions of the disk 1, the subsequence 31ᵢ-A, the group 30ᵢ₊₁ and the subsequence 31ᵢ-B. Exceptionally, the first sequential block 23₁ comprises upstream the navigation information group 30₁ associated d with the audiovisual information which it contains, and the last sequential block does not comprise any group of navigation information (the corresponding audiovisual sequence 31 is therefore not separated into two).

The partition into sequential blocks 23 relies on a predefined choice of the size of the navigation information groups 30, or on a criterion for determining this size.

More precisely (FIG. 3), each of the sequential blocks 23ᵢ is composed of a succession of information clusters 32-1, 32-2 . . . 32-Nᵢ. For simplicity, the index i is not indicated hereinbelow. The clusters 32-j (denoted 32 generically) have a fixed size, for example 128 k-bytes and are divided into tracks for the various types of data: video, audio and/or navigation. Each of these clusters 32 is apportioned into a first part constituting a header 33-1, 33-2 . . . 33-N (generic notation 33), which contains descriptive particulars about the cluster 32 (size of the header 33, for example equal by default to 512 bytes, presence of video, audio or other) and a second part constituting a payload. The payloads of the clusters 32-j respectively comprise successive sequence portions 34-j (generic notation 34). Moreover, the payload 34-k of one of the clusters 33-k of the sequential block 23 (for example the payload of the cluster 33-N for the sequential block 23 represented) comprises the group 30 of navigation information of the sequential block 23, followed by a portion 34-j (here 34-N) of audiovisual sequence.

The number Nᵢ of clusters 32 of sequential blocks 23 depends in particular on the bit rate of the stream 10. When this is constant, the size of the navigation information groups 30 being fixed, all the sequential blocks 23ᵢ generally have the same size, and hence consist of the same number Nᵢ=N of clusters 32.

During a recording, the following procedure (FIGS. 2 to 4) is preferably carried out, all the writes to the disk 1 being performed in consecutive locations (that is to say in consecutive LBAs) of the disk 1:
firstly, memory room necessary for the block 22 of general information is assigned and information required is registered therein (this information is updated in the course of the later steps); an area which can contain two groups of navigation information is also allocated in RAM memory;
a storage space is allocated for the group 30₁ of navigation information of the first sequential block 23₁ (step O);
the audiovisual information is recorded on the disk 1 following the group 30₁ as and when this information is received, in such a way as to form the portions 34 of the first subsequence 31₁-A of the sequential block 23₁(step A), while simultaneously producing in the allocated RAM area, navigation information in conjunction with this sequence 31₁;
as soon as 80% of the required size of the navigation information group 30₁ is acquired in the RAM area, a storage space for the navigation information group 30₂ which is to be stored on the disk 1 is allocated in the sequential block 23₁ downstream of the subsequence 31₁-A (step B);
the acquisition and recording of the first sequential block 31₁, is continued so as to form the portions 34 of the second subsequence 31₁-B of the sequential block 23₁ (step C), while producing navigation information in the RAM area until the size required for the group 30₁ is overshot;
and the navigation information group 30₁ thus obtained is saved in the storage space preallocated for this purpose (step D); the excess navigation information, which cannot be saved on the disk 1 at this time, constitutes the start of the group 30₂ of navigation information;
and for each of the sequential blocks 23ₖ, with k>1:
   the audiovisual information received is saved on the disk 1 so as to constitute the first subsequence 31ₖ-A of the sequential block 23ₖ (steps E and I for k=2 and 3 respectively), while simultaneously producing navigation information in conjunction with this sequence 31ₖ;
   before completing the registering of the sequence 31ₖ, to 80% fill of the group of navigation information in RAM memory, a storage space for the group 30₍ₖ₊₁₎ of navigation information of the next sequential block 23₍ₖ₊₁₎ is allocated consecutively to the recorded audiovisual information (steps F and J for k=2 and 3 respectively);
   the registering of the sequence 31ₖ immediately downstream of the storage space allocated for the group 30₍ₖ₊₁₎ is continued so as to constitute the second subsequence 31ₖ-B (steps G and K for k=2 and 3 respectively) and this registering is interrupted as soon as the predefined size of the navigation information produced in conjunction with this sequence 31ₖ is reached in memory;
   and the storage space allocated for the group 30ₖ of navigation information is filled (steps H and L for k=2 and 3 respectively).

In the course of a reading of this recording in the area 20, the reading device 4 can continuously follow the file in which the information is contained, by successively reading for each of the sequential blocks 23 the navigation information of the group 30 and the audiovisual information of the sequence 34 of this sequential block 23.

During normal reading, the reading device 4 thus directly accesses the images to be broadcast, instead of having to store complete groups of images in buffer memory. During forward play at fast speed and during reverse play, it directly accesses the positionings of the images to be broadcast, instead of having to sequentially traverse the recording or to refer to a distant file by successive to and fro movements of the reading head 5. The movements of the reading head 5, and hence the information access times and the noise generated, are thus minimized. Moreover, variations in bit rate are automatically allowed for in the distributing of the navigation information, because the size of the latter is established with respect to a given size, fixed in advance or obtained through a predetermined criterion.

In a second embodiment (FIG. 5), the recording device 2 systematically registers in an area 40 of the disk 1 the groups 50ᵢ of navigation information downstream of the sequences 31ᵢ of associated audiovisual information, for each of the sequential blocks 43ᵢ.

Thus, after the allocating of disk room for a block of general information 42 and the registering of the first corresponding information, the recording device 2 successively saves the clusters 34 of the first sequence 51₁ by producing in memory the corresponding navigation information. When the latter reaches the required memory size, a storage space is allocated on the disk 1 immediately downstream of the first sequence 51₁, and the navigation information (group 50₁) obtained for this sequence 51₁ is transferred thereto. We continue in a similar manner for the succeeding sequential blocks 43ᵢ, thus each consisting successively of a sequence 51ᵢ of a group 50ᵢ (respective generic notation: 43, 51, 50) up to the end of the recording.

This second embodiment is with regard to the first, advantageous through its simplicity. In particular, it does not require any backward jumps during writing for the recording of the navigation information. On the other hand, in read mode, the first embodiment offers faster access and less noise, since it does not require systematic traversals of the sequences 51 so as to have access to the associated navigation information, or systematic backward jumps so as to position itself on the targeted audiovisual information. This advantage is appreciable in particular in normal read mode.

1. Process for recording a set of multimedia digital data, preferably audio and/or video, on a direct-access recording medium (1), from a received stream (10) comprising at least broadcasting information, the said set comprising the said broadcasting information and navigation information, sufficient to implement at least one mode of reading the broadcasting information recorded on the recording medium (1), characterized in that the following operations are repeated:
new broadcasting information (31, 51) is recorded (A, E, I) on the recording medium (1) as and when the said broadcasting information is received,
the navigation information associated with the said new broadcasting information recorded on the recording medium (1) is determined and the said navigation information is held in buffer memory,
and the said navigation information (30, 50) contained in buffer memory is transferred (H, L) to the recording medium (1), while recording it contiguously in a storage space which is disposed within the said recorded broadcasting information (31, 51) and is associated with the said new recorded broadcasting information, the said storage space having a predetermined size.

2. Recording process according to claim 1, wherein said navigation information (30, 50) contained in buffer memory is transferred (H, L) into the said storage space when the said navigation information reaches the said predetermined size.

3. Recording process according to claim 1, wherein the said storage space for the navigation information (50) associated with a sequence (51) of the broadcasting information recorded on the recording medium (1) is disposed immediately downstream of the said sequence (51).

4. Recording process according to claim 1, wherein the following operations are repeated:
before the said new broadcasting information (31ₖ₊₁), is recorded on the recording medium (1), the said storage space scheduled to contain the navigation information (30ₖ₊₁) associated with the said new broadcasting information (31ₖ₊₁) is allocated (B, F, J) on the recording medium (1) consecutively to the previously recorded broadcasting information (31ₖ-A),
the said new broadcasting information (31ₖ₊₁) is recorded (E, I) downstream of the said storage space,
and the determined navigation information (30ₖ₊₁) held in buffer memory and associated with the said new broadcasting information (31ₖ₊₁) is recorded (H, L), in the said storage space.

5. Recording process according to claim 4, wherein the following operations are repeated:
one of the said storage spaces, the so-called current storage space, is allocated (B, F, J) when the navigation information, the so-called upstream navigation information, associated with the said new broadcasting information received, the so-called upstream broadcasting information, reaches a predetermined fraction of the said predetermined size,
the recording (C, G, K) on the recording medium (1) consecutively to the said current storage space, of the upstream broadcasting information (31ₖ₋₁), is continued, as is the determination of the associated upstream navigation information,
the said upstream navigation information (30ₖ₋₁) is recorded (D, H, L) in one of the said storage spaces, the so-called upstream storage space, previously allocated to the current storage space,
new broadcasting information, the so-called current broadcasting information (31ₖ₋₁), is recorded (E, I) consecutively to the upstream broadcasting information (31ₖ),
the navigation information associated with the current broadcasting information (31ₖ), the so-called current navigation information, is determined and held in buffer memory,
one of the said storage spaces, the so-called downstream storage space, is allocated (F, J) consecutively to the recorded current broadcasting information (31ₖ-A), when the-said current navigation information reaches the said predetermined fraction of the said predetermined size,
the recording (G, K) on the recording medium (1) consecutively to the downstream storage space, of the current broadcasting information (31ₖ), is continued,
the current navigation information (30ₖ) is recorded (H, L) in the current storage space, and
new broadcasting information, the so-called downstream broadcasting information (31ₖ₊₁), is recorded (I) consecutively to the current broadcasting information (31ₖ) and the associated navigation information, the so-called downstream navigation information, is determined and held in buffer memory.

6. Recording process according to claim 5, wherein the said predetermined fraction of the said predetermined size lies between 75% and 85%, and preferably between 79% and 81%, of the said size.

7. Recording process according to claim 1, wherein the said reading modes implementable by means of the navigation information comprise at least one special effects mode.

8. Recording process according to claim 1, wherein the data set recorded on the recording medium (1) is sent to at least one recording apparatus comprising a direct-access final recording medium.

9. Recording process according to claim 1, wherein at least a part of the said navigation information is produced by performing a syntactic analysis of the broadcasting information of the stream (10).

10. Recording process according to claim 1, wherein, because the stream received is analogue, the said navigation information is produced by encoding the said stream after digitization.

11. Recording process according to claim 1, wherein the navigation information contains decryption keys.

12. Device (2) for recording sets of multimedia digital data, preferably audio and/or video, on a direct-access recording medium (1), from a received stream (10) comprising at least broadcasting information, the said sets comprising the said broadcasting information and navigation information, sufficient to implement at least one mode of reading the broadcasting information recorded on the recording medium (1), characterized in that the said recording device (2) is scheduled for implementing the recording process according to claim 1.

13. Hard disk (1) on which is recorded at least one set of multimedia digital data, preferably audio and/or video, having direct access, the said data comprising broadcasting information and navigation information making it possible to obtain at least one position in the recorded broadcasting information, wherein the said hard disk (1) comprises in consecutive locations, sequential blocks (23, 43) each comprising a sequence (31, 51) of broadcasting information and a group (30, 50) of navigation information, which group is associated with the said sequence or with the sequence of the sequential block immediately downstream of the said sequence, the said navigation information being sufficient to implement at least one mode of reading the broadcasting information of the said recorded data set.

14. Medium (1) for recording at least one set of multimedia digital data, preferably audio and/or video, having direct access, the said support (1) comprising a succession of sequential blocks (23, 43) each comprising a sequence (31, 51) of broadcasting information and a group (30, 50) of navigation information, which group is associated with broadcasting information downstream of the said group, the said navigation information being sufficient to implement at least one mode of reading the broadcasting information of the said recorded data set, wherein the groups (30) of navigation information are inserted into the sequences (31) of broadcasting information, each of the said sequences (31) of broadcasting information consisting of an upstream subsequence (31-A) and of a downstream subsequence (31-B) which are separated by one of the said groups (30) of navigation information, the said downstream subsequence (31-B) being associated at least partially with navigation information upstream of the said upstream subsequence (31-A).

15. String of multimedia digital data, preferably audio and/or video, which is intended to be recorded on at least one direct-access recording medium (1), the said string comprising a succession of sequential blocks (23, 43) each comprising a sequence (31, 51) of broadcasting information and a group (30, 50) of navigation information, which group is associated with broadcasting information downstream of the said group, the said navigation information being sufficient to implement at least one mode of reading the broadcasting information of the said data set recorded on the said recording medium (1), by dint of prior tailoring of the said navigation information to the said recording medium (1), wherein the groups (30) of navigation information are inserted into the sequences (31) of broadcasting information, each of the said sequences (31) of broadcasting information consisting of an upstream subsequence (31-A) and of a downstream subsequence (31-B) which are separated by one of the said groups (30) of navigation information, the said downstream subsequence (31-B) being associated at least partially with navigation information upstream of the said upstream subsequence (31-A).
